(19) United States
(12) Patent Application Publication
(10) Pub. No.: US 2022/0023978 A1
(43) Pub. Date: Jan. 27, 2022

(54) METHOD FOR MONITORING THE QUALITY OF ULTRASONIC WELDING

(71) Applicant: Lisa Draexlmaier GmbH, Vilsbiburg (DE)

(72) Inventors: Felix Klimas, Langquaid (DE); Thomas Herzing, Landshut (DE); Lutz Lehmann, Landshut (DE); Daniel Zemann, Landshut (DE)

(73) Assignee: Lisa Draexlmaier GmbH, Vilsbiburg (DE)

(21) Appl. No.: 17/497,343

(22) Filed: Oct. 8, 2021

Related U.S. Application Data
(63) Continuation of application No. PCT/EP2020/059138, filed on Mar. 31, 2020.

(30) Foreign Application Priority Data
Apr. 9, 2019 (DE) 10 2019 109 264.7

(51) Int. Cl. B23K 31/12; B23K 20/10; B23K 20/00; G01N 29/12; G01N 29/46

(52) U.S. Cl. CPC B23K 31/125; B23K 20/10; B23K 2101/38; G01N 29/12; G01N 29/46; B23K 20/004

(57) ABSTRACT

A method for monitoring the quality of an ultrasonic weld includes monitoring a vibration behavior during a joining process with respect to an actual value of a vibration frequency and/or a vibration amplitude of at least one joining partner of joining partners involved in the joining process. A tool of an ultrasonic welding device is used in the joining process, and at least one measuring device is configured to quantify mechanical vibrations. The detected vibration behavior is analyzed using a Fourier analysis and compared to a predefined set value as reference value.

### CROSS-REFERENCE TO RELATED APPLICATIONS

This application is a continuation of International Application No. PCT/EP2020/059138, filed on Mar. 31, 2020, which claims priority to and the benefit of DE 10 2019 109 264.7, filed on Apr. 9, 2019. The disclosures of the above applications are incorporated herein by reference.

### FIELD

The present disclosure relates to systems for monitoring of a quality of an ultrasonic weld.

### BACKGROUND

The statements in this section merely provide background information related to the present disclosure and may not constitute prior art.

Ultrasonic welding can be used for joining of cable packets. In this regard, modern ultrasonic welding equipment allows precise and repeatable processes due to digital ultrasound generating technology and the use of microprocessors. When adjusting the parameters for different applications and materials, values gained from experience are usually referred to. However, monitoring of the joining process is challenging since a destructive test is usually performed after the welding process.

A destructive test of the parts is generally required for the majority of the parameters to be determined when assessing the quality of the ultrasonic weld. Furthermore, the evaluation of the connecting location occurs only after the welding, that is, after the process has already been completed. Thus methods of this kind can only be performed for the detection of flaws.

Likewise, with the destructive testing, production is impacted since parts have to be removed from the production run.

Additional factors, such as contaminants or impurities in the joining parts, bring in further incalculable parameters.

### SUMMARY

This section provides a general summary of the disclosure and is not a comprehensive disclosure of its full scope or all of its features.

A measurement and evaluation of quantities that characterize a vibration process during the welding process make possible a comprehensive and powerful assessment of the welding process. The evaluation using a Fourier analysis allows a temporal assessment of the quality of the welding process. In this regard, the quality comprises a purity and/or a connection quality of the ultrasonic weld.

According to a first aspect, the present disclosure includes a method for monitoring a quality of an ultrasonic weld, wherein the vibration behavior during the joining process is monitored with respect to an actual value of the vibration frequency and/or the vibration amplitude of at least one of the joining parts involved in the joining process and/or of the tool of an ultrasonic welding device used in the joining process, by measuring using at least one measuring device which is configured to quantify mechanical vibrations. The detected vibration behavior is analyzed using a Fourier analysis and compared to a predefined target value as reference value.

The Fourier analysis can comprise a use of a short-term Fourier analysis, from which the temporal dependence of the amplitude, frequency, or other values can be determined. Individual window sections of the short-term Fourier analysis can refer back to a suitable window function, in particular in the calculating of an amplitude to a flattop window, in the calculating of a frequency or of a phase to a rectangular window. Zero padding and interpolation likewise can be applied, in particular in the calculating of a frequency in a short-term Fourier analysis with small window sizes.

In one form, an optical measuring device is used to quantify the mechanical vibrations during the joining process.

In one form, an eddy current sensor and/or a laser vibrometer is used to quantify the mechanical vibrations during the joining process. A laser vibrometer can measure at one or more measurement points and detect at least one vibration parameter such as the vibration frequency or the vibration amplitude, for example.

The measuring of the deflection can be effected with different measurement methods. The deflection can also be measured in particular by an eddy current sensor. In this regard, an adverse mechanical effect can be avoided during the welding process. In particular, the deflection, that is, also the speed of the sonotrode, is measured with a device in which an eddy current sensor is moved as close as possible to a measurement point on the sonotrode surface, which is positioned orthogonal to the direction of movement and thus at a right angle to the coupling surface.

In particular the measurement point can be located as close as possible to the coupling surface in order to obtain the most accurate measurement possible of the movement in the joining zone. The eddy current sensor is particularly well suited for this task since it can be moved relatively easily to different locations of the vibration system. Any restriction on the technician is thus also less than for measurements using laser-optical systems, such as laser vibrometry. A combination of the two mentioned measurement methods with each other or with additional measurements can increase an accuracy of the measurement.

In one form, a plurality of measurement points are monitored by the measurement device with regard to their vibration behavior differing from the target values.

In one form, one measurement point on a sonotrode, an anvil, a first joining part, in particular a first conductor, and/or a second joining part, in particular a second conductor, is used to quantify their mechanical vibrations.

In one form, to determine the target values as the reference value for a specified pair of joining parts, a pair of uncontaminated, in particular cleaned, joining parts is used, and using the measurement device the quantifying of the mechanical vibrations is captured during the joining process by the vibration amplitude and/or vibration frequency being detected at one or more reference points. The average of a plurality of such reference measurements can also be formed.

In one form, a measure for the relative deviation of the detected actual values, and in one form the detected vibration amplitude and/or vibration frequency from the particular target value is used as a measure for the purity and thus quality of the connection of the joining partners. Furthermore, a display device can be provided which displays a reference curve of an uncontaminated pair of joining parts on its display screen, and for this purpose the current measured curve can be displayed superimposed thereon or imaged on the same view, so that already from the deviation of the displayed curves, a user can readily detect a deviation from a good weld.

In one form, in case of a relative deviation of the detected actual value from the corresponding target value, which is greater than a predetermined limit value, the joining process is interrupted and/or the joining partners are detected as unacceptable parts.

In one form, the limit value is at most 10%, in particular at most 5%.

In one form, a frequency shift is detected between an excitation frequency of the ultrasonic welding device and a frequency measured at a measurement point during the joining process and is compared to a saved target-frequency shift in order to determine a degree of purity of the joining partners based on the amount of the frequency shift.

According to a second aspect of the present disclosure, a device to implement a method according to the first aspect, including an ultrasonic welding device and a measurement device which is configured to detect the vibration behavior during the joining process, to analyze the detected vibration behavior using a Fourier analysis, and to compare the detected behavior to a predetermined target value as a reference value in order to monitor the quality of an ultrasonic weld. The measurement device can comprise an eddy current sensor and/or a laser vibrometer.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic representation of a device according to the teachings of present disclosure; and

FIG. 2 shows a flow chart for a method according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

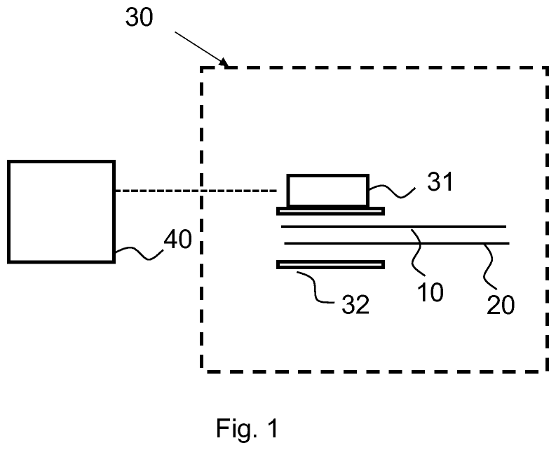

FIG. 1 shows a schematic view of a device according to one form of the present disclosure including an ultrasound welding device 30 including a tool including a sonotrode 31 and an anvil 32, between which joining partners 10, 20 are arranged in order to weld them using a vibrational excitation of the sonotrode 31.

The ultrasound welding device 30 is provided with an optical measurement device 40 which is arranged such that a mechanical vibration behavior can be detected. In the described form, the measurement device 40 is a laser vibrometer. Wires of a cable harness are used as joining partners 10, 20. In a further form, different joining partners are used. In a further form, the measurement device 40 comprises an eddy current sensor which is attached near the sonotrode surface.

The measurement device 40 serves for detecting and quantifying the mechanical vibrations, in the present case, the occurring vibration frequency at the sonotrode 31 or at one of the joining partners 10, 20 during the joining process.

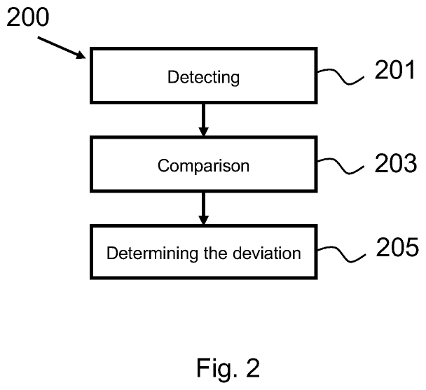

FIG. 2 shows a flow chart for a method according to one form of the present disclosure.

In step 201, the measurement device 40 detects the vibration data, in particular frequency and amplitude, and analyzes the frequency and amplitude using a Fourier analysis. The measurement device then compares the analyzed vibration data in step 203 to a target value and/or to target reference data. If a deviation is found in step 205, then the sample can be deemed as contaminated if the deviation is greater than the permissible limit value.

If no deviation is found or if a deviation of less than the permissible limit value is found in step 205, then the weld can be deemed as good or acceptable.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for monitoring quality of an ultrasonic weld, the method comprising:
monitoring a vibration behavior during a joining process with respect to an actual value of at least one of:
at least one of a vibration frequency and a vibration amplitude of at least one joining partner of joining partners involved in the joining process; and
at least one of a vibration frequency and a vibration amplitude of a tool of an ultrasonic welding device used in the joining process,
by measuring with at least one measuring device configured to quantify mechanical vibrations,
wherein a detected vibration behavior is analyzed using a Fourier analysis and compared to a predefined target value as a reference value.

2. The method according to claim 1, wherein an optical measurement device is used to quantify the mechanical vibrations during the joining process.

3. The method according to claim 1, wherein at least one of an eddy current sensor and a laser vibrometer is used to quantify the mechanical vibrations during the joining process.

4. The method according to claim 1, wherein a plurality of measurement points are monitored by the at least one measuring device with regard to vibration behavior of the measurement points differing from respective target values.

5. The method according to claim 4, wherein one measurement point on at least one of a sonotrode, an anvil, a first joining partner, and a second joining partner is used to quantify the mechanical vibrations.

6. The method according to claim 5, wherein the first joining partner is a first conductor.

7. The method according to claim 5, wherein the second joining partner is a second conductor.

8. The method according to claim 1, wherein to determine the predefined target value as the reference value for a specified pair of joining partners, a pair of uncontaminated joining partners is used, and using the measurement device a quantifying of the mechanical vibrations is captured during the joining process by at least one of the vibration amplitude and the vibration frequency being detected at one or more reference points.

9. The method according to claim 8, wherein the pair of uncontaminated joining partners are a pair of cleaned joining partners.

10. The method according to claim 1, further comprising measuring for a relative deviation of the actual value, from the predefined target value, is used as a measure for a purity of a connection of the joining partners.

11. The method according to claim 10, wherein when the relative deviation of the actual value from a corresponding predefined target value is greater than a predetermined limit value, at least one of the joining process is interrupted and the joining partners are detected as unacceptable parts.

12. The method according to claim 11, wherein the predetermined limit value is less than or equal to 10%.

13. The method according to claim 12, wherein the predetermined limit value less than or equal to 5%.

14. The method according to claim 1, wherein a frequency shift between an excitation frequency of the ultrasonic welding device and a frequency measured at a measurement point during the joining process is detected and is compared to a saved set-frequency shift to determine a degree of purity of the joining partners based on an amount of the frequency shift.

15. A device to implement the method according to claim 1, the device comprising:
an ultrasonic welding device; and
a measurement device configured to detect the vibration behavior during the joining process, to analyze the detected vibration behavior using the Fourier analysis, and to compare the detected vibration behavior to a predetermined target value as a reference value to monitor the quality of the ultrasonic weld.

16. The device according to claim 15, wherein the measurement device comprises at least one of an eddy current sensor and a laser vibrometer.
